(19) United States
(12) Patent Application Publication
(10) Pub. No.: US 2026/0170251 A1
(43) Pub. Date: Jun. 18, 2026

(54) METHOD AND SYSTEM OF CONTEXTUALIZED SKILL EXTRACTION FROM DOCUMENTS

(71) Applicant: Wipro Limited, Bangalore (IN)

(72) Inventors: Santanu PAL, West Bengal (IN); Noha EL-ZEHIRY, Princeton, NJ (US); Nabarun BARUA, Bengalaru (IN)

(73) Assignee: Wipro Limited, Bangalore (IN)

(21) Appl. No.: 19/203,798

(22) Filed: May 9, 2025

(30) Foreign Application Priority Data
Dec. 17, 2024 (IN) 202441100168

(51) Int. Cl. G06F 40/295; G06F 40/284; G06N 3/047

(52) U.S. Cl. CPC G06F 40/295; G06F 40/284; G06N 3/047

(57) ABSTRACT

The method of contextualized skill extraction from electronic documents. The method includes receiving, via user interface, electronic document from user device. The method further includes generating plurality of words in the electronic document using pre-trained embedding model. The method further includes generating plurality of second embeddings from the plurality of first embeddings based on weighted averaging operation using first ANN layer. The method further includes generating plurality of contextualized embeddings from the plurality of second embeddings and the plurality of first embeddings using addition and normalization layer. The method further includes predicting named entity tag from set of named entity tags for each of the plurality of contextualized embeddings using fine-tuned second ANN layer. The method further includes extracting one or more skills from the electronic document based on the named entity tag corresponding to each of the plurality of contextualized layers.

### TECHNICAL FIELD

This disclosure relates generally to Artificial Intelligence (AI), and more particularly to method and system of contextualized skill extraction from electronic documents.

### BACKGROUND

An ever-increasing number of applications to job positions presents a challenge for employers to manually identify suitable candidates. Manually finding the suitable candidates may involve huge efforts. There are a multitude of factors such as evaluation of the candidate's soft skills, accounting for company demands, judging the veracity of the candidate's resume, specific skill extraction, or the like may itself be a challenge at the first step. The results obtained by automating these steps through machine learning and natural language processing are not satisfactory. Specifically, skill extraction process suffers in detecting contextual spans within a soft-skill or hard-skill, which should also be taken into consideration during skill extraction process. Apart from that, the scarcity of available dataset for skill extraction is also one of the major challenges

Various techniques have been developed for overcoming the above mentioned problems by utilizing an advanced machine learning (ML) and a Natural Language Processing (NLP). However, the existing techniques are more intricate and computationally expensive due to a combination of convolutional and concurrent layers. Further, the existing techniques may use computationally intensive complex architectures that may require separate entity and extraction modules. This complexity may lead to slower training and inference times during large datasets. Further, the existing techniques may be inefficient for tasks (such as resume parsing and skill extraction) where the focus may be only on identifying phrases rather than relationships. Therefore, there is a need for a simplified skill extraction process that may extract the hard and soft skills efficiently from the description and resumes (i.e., electronic documents) using the machine learning. Example electronic documents may include documents in a variety of different file formats, such as Microsoft Word 97, Rich Text Format, PDF, WordPerfect, ASCII files, and HTML that are stored within a computer. Further, these electronic documents may be processed by computer program applications in a manner similar to how database applications process structured data in the documents that are written in natural language.

The present invention is directed to overcome one or more limitations stated above or any other limitations associated with the known arts.

### SUMMARY

In one embodiment, a method of contextualized skill extraction from electronic documents is disclosed. In one example, the method may include receiving, via a user interface, an electronic document from a user device. The electronic document may include a plurality of words. The method may further include generating a plurality of first embeddings corresponding to each of the plurality of words in the electronic document using a pre-trained embedding model. It should be noted that the plurality of first embeddings is based on a plurality of sub-words corresponding to the plurality of words. The method may further include generating a plurality of second embeddings from the plurality of first embeddings based on a weighted averaging operation using a first Artificial Neural Network (ANN) layer. The method may further include generating a plurality of contextualized embeddings from the plurality of second embeddings and the plurality of first embeddings using an addition and normalization layer. The method may further include predicting a named entity tag from a set of named entity tags for each of the plurality of contextualized embeddings using a fine-tuned second ANN layer. The method may further include extracting one or more skills from the electronic document based on the named entity tag corresponding to each of the plurality of contextualized layers. It should be noted that each of the one or more skills is a span of one or more contextualized embeddings corresponding to one or more words.

In another embodiment, a system for contextualized skill extraction from electronic documents is disclosed. In one example, the system may include a processor and a computer-readable medium communicatively coupled to the processor. The computer-readable medium may store processor-executable instructions, which, on execution, may cause the processor to receive, via a user interface, an electronic document from a user device. The electronic document may include a plurality of words. The processor-executable instructions, on execution, may further cause the processor to generate a plurality of first embeddings corresponding to each of the plurality of words in the electronic document using a pre-trained embedding model. It should be noted that the plurality of first embeddings is based on a plurality of sub-words corresponding to the plurality of words. The processor-executable instructions, on execution, may further cause the processor to generate a plurality of second embeddings from the plurality of first embeddings based on a weighted averaging operation using a first ANN layer. The processor-executable instructions, on execution, may further cause the processor to generate a plurality of contextualized embeddings from the plurality of second embeddings and the plurality of first embeddings using an addition and normalization layer. The processor-executable instructions, on execution, may further cause the processor to predict a named entity tag from a set of named entity tags for each of the plurality of contextualized embeddings using a fine-tuned second ANN layer. The processor-executable instructions, on execution, may further cause the processor to extract one or more skills from the electronic document based on the named entity tag corresponding to each of the plurality of contextualized layers. It should be noted that each of the one or more skills is a span of one or more contextualized embeddings corresponding to one or more words.

In yet another embodiment, a non-transitory computer-readable medium storing computer-executable instruction for contextualized skill extraction from electronic documents is disclosed. In one example, the stored instructions, when executed by a processor, may cause the processor to perform operations including receiving, via a user interface, an electronic document from a user device. The may include a plurality of words. The operations may further include generating a plurality of first embeddings corresponding to each of the plurality of words in the electronic document using a pre-trained embedding model. It should be noted that the plurality of first embeddings is based on a plurality of sub-words corresponding to the plurality of words. The operations may further include generating a plurality of second embeddings from the plurality of first embeddings based on a weighted averaging operation using a first ANN layer. The operations may further include generating a plurality of contextualized embeddings from the plurality of second embeddings and the plurality of first embeddings using an addition and normalization layer. The operations may further include predicting a named entity tag from a set of named entity tags for each of the plurality of contextualized embeddings using a fine-tuned second ANN layer. The operations may further include extracting one or more skills from the electronic document based on the named entity tag corresponding to each of the plurality of contextualized layers. It should be noted that each of the one or more skills is a span of one or more contextualized embeddings corresponding to one or more words.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for contextualized skill extraction from electronic documents, in accordance with some embodiments of the present disclosure.

FIG. 2 illustrates a functional block diagram of a system for contextualized skill extraction from electronic documents, in accordance with some embodiments of the present disclosure.

FIG. 3A illustrates a flow diagram of an exemplary process for contextualized skill extraction from electronic documents from step 302 to step 314, in accordance with some embodiments of the present disclosure.

FIG. 3B illustrates the flow diagram showing continuation of the exemplary process of FIG. 3A from step 316 to step 326, in accordance with some embodiments of the present disclosure.

FIG. 4 illustrates a flow diagram of a detailed exemplary process for contextualized skill extraction from electronic documents, in accordance with some embodiments of the present disclosure.

FIG. 5 illustrates a functional block diagram of another system for fine-tuning an ANN model using a fine-tuning dataset, in accordance with some embodiments of the present disclosure.

FIG. 6 illustrates a flow diagram of an exemplary process for fine-tuning an ANN model using a fine-tuning dataset, in accordance with some embodiments of the present disclosure.

FIG. 7 illustrates a flow diagram of a detailed exemplary process for fine-tuning an ANN model using a fine-tuning dataset, in accordance with some embodiments of the present disclosure.

FIG. 8 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

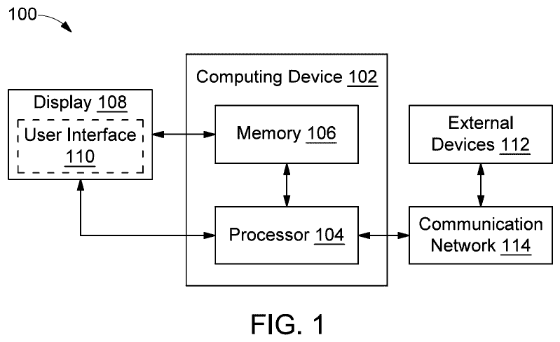

Referring now to FIG. 1, an exemplary system 100 for contextualized skill extraction from electronic documents is illustrated, in accordance with some embodiments of the present disclosure. The system 100 may include a computing device 102. The computing device 102 may be, for example, but may not be limited to, server, desktop, laptop, notebook, netbook, tablet, smartphone, mobile phone, or any other computing device, in accordance with some embodiments of the present disclosure. The computing device 102 may extract one or more skills from electronic documents using a custom Artificial Neural Network (ANN) model including at least two ANN layers. In an embodiment, the at least two ANN layers may include a first Multi-Layer Perceptron (MLP) layer and a second MLP layer.

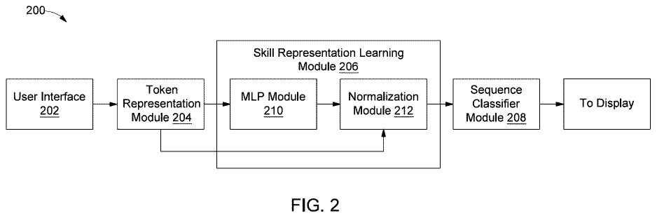

As will be described in greater detail in conjunction with FIGS. 2-8, the computing device 102 may receive, via a user interface, an electronic document from a user device. The electronic document may include a plurality of words. The computing device 102 may further generate a plurality of first embeddings corresponding to each of the plurality of words in the electronic document using a pre-trained embedding model. It should be noted that the plurality of first embeddings is based on a plurality of sub-words corresponding to the plurality of words. The computing device 102 may further generate a plurality of second embeddings from the plurality of first embeddings based on a weighted averaging operation using a first ANN layer. The computing device 102 may further generate a plurality of contextualized embeddings from the plurality of second embeddings and the plurality of first embeddings using an addition and normalization layer. The computing device 102 may further predict a named entity tag from a set of named entity tags for each of the plurality of contextualized embeddings using a fine-tuned second ANN layer. The computing device 102 may further extract one or more skills from the electronic document based on the named entity tag corresponding to each of the plurality of contextualized layers. Each of the one or more skills is a span of one or more contextualized embeddings corresponding to one or more words.

In some embodiments, the computing device 102 may include one or more processors 104 and a memory 106. Further, the memory 106 may store instructions that, when executed by the one or more processors 104, may cause the one or more processors 104 to extract contextualized skills from the electronic documents, in accordance with aspects of the present disclosure. The memory 106 may also store various data (for example, a plurality of electronic documents, a plurality of first embeddings, a plurality of contextualized embedding, a plurality of second embeddings, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user interface 110 accessible via the display 108. The system 100 may also include one or more external devices 112. In some embodiments, the computing device 102 may interact with the one or more external devices 112 over a communication network 114 for sending or receiving various data. The communication network 114 may include, for example, but may not be limited to, a wireless fidelity (Wi-Fi) network, a light fidelity (Li-Fi) network, a local area network (LAN), a wide area network (WAN), a metropolitan area network (MAN), a satellite network, the internet, a fiber optic network, a coaxial cable network, an infrared (IR) network, a radio frequency (RF) network, and a combination thereof. The one or more external devices 112 may include, but may not be limited to, a remote server, a laptop, a netbook, a notebook, a smartphone, a mobile phone, a tablet, or any other computing device.

Referring now to FIG. 2, a functional block diagram of a system 200 for contextualized skill extraction from electronic documents is illustrated, in accordance with some embodiments of the present disclosure. FIG. 2 is explained in conjunction with FIG. 1. The system 200 may be analogous to the system 100. The system 200 may be implemented the computing device 102. The computing device 102 may render a user interface 202 (analogous to the user interface 110) through a display (such as the display 108). Alternatively, the user interface 202 may be rendered on a user device (such as, but not limited to, a laptop, a netbook, a notebook, a smartphone, a mobile phone, a tablet, or any other computing device). In such an embodiment, the user device may be communicatively coupled to the computing device 102. The memory 106 of the computing device 102 may include a token representation module 204, a skill representation learning module 206, and a sequence classifier module 208. The skill representation learning module 206 may further include an MLP module 210 and a normalization module 212.

Initially, in an inference stage, the token representation module 204 may receive, via the user interface 202, an electronic document. The electronic document, for example, may be, but may not be limited to, a job description, a resume, a curriculum vitae (CV), or the like. The electronic document may be received in a text or a document format, such as, a Portable Document Format (PDF), a word document (DOC, or DOCX), HTML, or the like. The electronic document may be any document from which a user (e.g., an employer, Human Resource (HR), and the like) wants to extract skills. By way of an example, the electronic document may include skills. The skills may be represented by phrases or combinations of words that may convey a specific expertise, capability, or proficiency in a particular area. These multi-words may vary in length and complexity, ranging from simple terms (such as programming language, data analysis, or the like) to more elaborate descriptions (such as Machine Learning (ML) algorithms, statistical modeling techniques, or the like).

The received input (i.e., the electronic document) may include a set of sentences (or set of sequences). Each sentence includes a set of words (or tokens). All input words are first tokenized into multiple sub-words through techniques such as stemming. For each word in the input text, the representation (embeddings) of the first sub-word is used, ensuring consistency in capturing key terms.

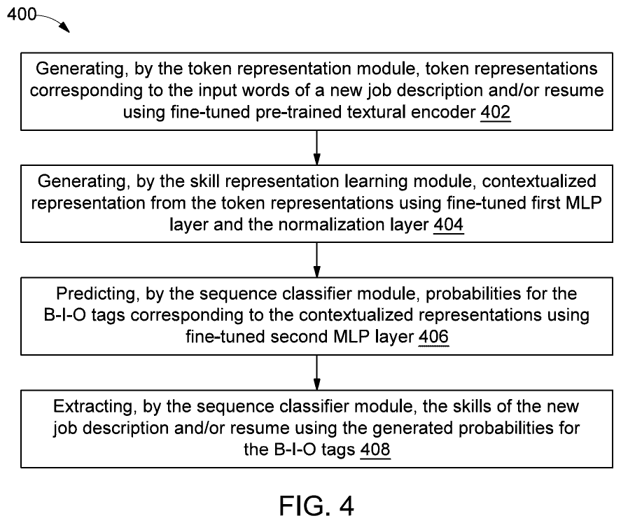

The token representation module 204 may include a fine-tuned pre-trained textual encoder (or a pre-trained embedding model) such as, but not limited to, JOBBERT (a Bidirectional Language Model pretrained on BERT). Further, the token representation module 204 may generate a plurality of first embeddings (i.e., token representations) corresponding to the set of words in each of the set of sentences in the electronic document using the fine-tuned pre-trained textual encoder. The fine-tuned pre-trained textual encoder may be trained or fine-tuned using a fine-tuning dataset. This is further explained in greater detail in conjunction with FIGS. 5-7. Further, the token representation module 204 may send (or provide) the plurality of first embeddings to the MLP module 210 and the normalization module 212.

Further, the MLP module 210 may generate a plurality of second embeddings (i.e., enhanced representations) from the plurality of first embeddings based on a weighted averaging operation using a first ANN layer. In an embodiment, the first ANN layer may be a fine-tuned first MLP layer. The first ANN layer may be fine-tuned using a fine-tuning dataset. This is further explained in greater detail in conjunction with FIGS. 5-8. The first ANN layer may include a fully connected position wise feed-forward network. The first ANN layer may use the fully connected position wise feed-forward network for the weighted averaging operation. To perform the weighted averaging operation, the MLP module 210 may compute a weighted average score corresponding to each of the plurality of first embeddings based on a learnable weight matrix using the first ANN layer, to obtain the plurality of second embeddings.

The MLP module 210 may then provide the plurality of second embeddings to the normalization module 212. Thus, the normalization module 212 may receive the plurality of first embeddings from the token representation module 204 and the plurality of second embeddings from the MLP module 210. The normalization module 212 may include an addition and normalization layer. Further, the normalization module 212 may generate a plurality of contextualized embeddings from the plurality of second embeddings and the plurality of first embeddings using the addition and normalization layer. The addition and normalization layer may be fine-tuned using a fine-tuning dataset. This is further explained in greater detail in conjunction with FIGS. 5-7.

To generate the plurality of contextualized embeddings, the normalization module 212 may perform, through the addition and normalization layer, an addition operation on the plurality of second embeddings with the plurality of first embeddings, to obtain a plurality of combined embeddings. Further, the normalization module 212 may perform, through the addition and normalization layer, a normalization operation on the plurality of combined embeddings to obtain the plurality of contextualized embeddings. Further, the normalization module 212 may provide the plurality of contextualized embeddings to the sequence classifier module 208.

The sequence classifier module 208 may predict a named entity tag from a set of named entity tags for each of the plurality of contextualized embeddings using a fine-tuned second ANN layer. In an embodiment, the fine-tuned second ANN layer may be a fine-tuned second MLP layer. In an embodiment, the set of named entity tags may include a ‘B’ tag, an ‘I’ tag, and an ‘O’ tag, where the ‘B’ tag corresponds to beginner, the ‘I’ tag corresponds to intermediate, and the ‘O’ tag corresponds to the other. In particular, the sequence classifier module 208 may transform the plurality of contextualized embeddings into a plurality of output embeddings using the fine-tuned second ANN layer for further processing (or downstream tasks). The fine-tuned second ANN layer may convert low values or negative values of weighted average scores to zero.

The fine-tuned second ANN layer may include two linear layers with a ReLU activation and a projection layer. The projection layer may further include a third linear layer and a layer with a sigmoid activation function.

To predict the named entity tag for each of the plurality of contextualized embeddings, the sequence classifier module 208 may perform, through the fine-tuned second ANN layer, a thresholding operation on the plurality of contextualized embeddings using the two linear layers with the ReLU activation. Further, for each of the plurality of contextualized embeddings, the sequence classifier module 208 may calculate, through the fine-tuned second ANN layer, a probability vector corresponding to the set of named entity tags using the third linear layer and the layer with the sigmoid activation function. In particular, the sequence classifier module 208 may pass the plurality of contextualized embeddings through the linear of a projection layer. Further, the sequence classifier module 208 may pass the plurality of contextualized embeddings through the sigmoid activation function to generate the probability vector for each of the plurality of contextualized embeddings.

It should be noted that the probability vector may include a probability score of a contextualized embedding corresponding to each of the set of named entity tags. In an embodiment where the set of named entity tags includes ‘B’, ‘I’, and ‘O’ tags, probability vector may be a three-element vector having ‘B’, ‘I’, and ‘O’ tags, and corresponding probabilities.

Further, for each of the plurality of contextualized embeddings, the sequence classifier module 208 may determine, through the fine-tuned second ANN layer, the named entity tag based on the calculated probability vector. For example, the probability vector corresponding to a word may be [0.5, 0.3, 0.2]. In other words, the probability vector may include a probability of 0.5 corresponding to the ‘B’ tag, a probability of 0.3 corresponding to the ‘I’ tag, and a probability of 0.2 corresponding to the ‘O’ tag. Then, the named entity tag corresponding to the word may be determined as the ‘B’ tag (i.e., the named entity tag with the highest probability score in the probability vector).

Further, the sequence classifier module 208 may extract one or more skills from the electronic document based on the named entity tag corresponding to each of the plurality of contextualized embeddings. It should be noted that each of the one or more skills is a span of one or more contextualized embeddings corresponding to one or more words. A skill may start from a word with a named entity tag indicative of beginning of the skill. The skill may span till a word with a named entity tag indicative of ending of the skill. For example, for a phrase “ . . . highly skilled in Machine Learning and . . . ”, the named entity tag for the word ‘Machine’ may be ‘B’ tag, the named entity tag for the word ‘Learning’ may be ‘I’ tag, and the named entity tag for the word ‘and’ may be ‘O’ tag. The extracted skill may span from the word with the ‘B’ tag till before the word with the next ‘O’ tag. Thus, the extracted skill in the above mentioned example may be ‘Machine Learning’. Further, the sequence classifier module 208 may render, via the user interface 202, the one or more skills extracted from the electronic document on the user device or the display of the computing device 102.

It should be noted that all such aforementioned modules 204-212 may be represented as a single module or a combination of different modules. Further, as will be appreciated by those skilled in the art, each of the modules 204-212 may reside, in whole or in parts, on one device or multiple devices in communication with each other. In some embodiments, each of the modules 204-212 may be implemented as dedicated hardware circuit comprising custom application-specific integrated circuit (ASIC) or gate arrays, off-the-shelf semiconductors such as logic chips, transistors, or other discrete components. Each of the modules 204-212 may also be implemented in a programmable hardware device such as a field programmable gate array (FPGA), programmable array logic, programmable logic device, and so forth. Alternatively, each of the modules 204-212 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for contextualized skill extraction from electronic documents. For example, the exemplary system 100 and the associated computing device 102, may perform contextualized skill extraction from the electronic documents, by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

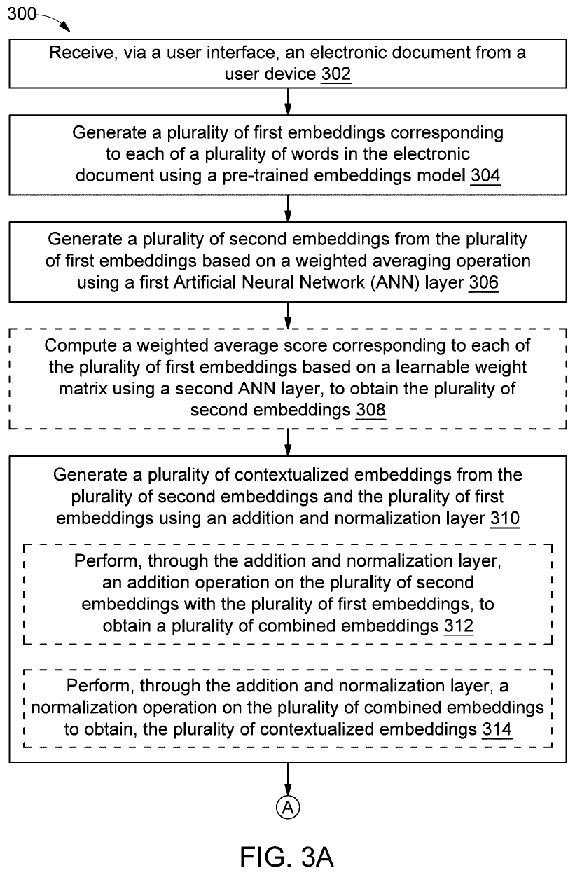

Referring now to FIGS. 3A and 3B, an exemplary process 300 for contextualized skill extraction from electronic documents is illustrated via a flow chart, in accordance with some embodiments of the present disclosure. The process 300 may be implemented by the computing device 102 of the system 100. In some embodiments, the process 300 may include receiving, by a token representation module (such as the token representation module 204) via a user interface (such as the user interface 202), an electronic document from a user device, at step 302. The electronic document may include a plurality of words.

Upon receiving the electronic document, the process 300 may include generating, by the token representation module, a plurality of first embeddings corresponding to each of the plurality of words in the electronic document using a pre-trained embedding model, at step 304. It should be noted that the plurality of first embeddings is based on a plurality of sub-words corresponding to the plurality of words. Further, upon generating the plurality of first embeddings, the process 300 may include generating, by an MLP module (such as the MLP module 210), a plurality of second embeddings from the plurality of first embeddings based on a weighted averaging operation using a first ANN layer, at step 306. Further, for the weighted average operation, the process 300 may include computing, by the MLP module, a weighted average score corresponding to the plurality of first embeddings based on a learnable weight matrix using the first ANN layer, to obtain the plurality of second embeddings, at step 308.

Upon generating the plurality of second embeddings, the process 300 may include generating, by a normalization module (such as the normalization module 212), a plurality of contextualized embeddings from the plurality of second embeddings and the plurality of first embedding using an addition and normalization layer, at step 310. The step 310 may include steps 312 and 314.

To generate the plurality of contextualized embeddings, the process 300 may include performing, by the normalization module, through the addition and normalization layer, an addition operation on the plurality of second embeddings with the plurality of first embeddings, to obtain a plurality of combined embeddings, at step 312. Further, upon obtaining the plurality of combined embeddings, the process 300 may include performing, by the normalization module, through the addition and normalization layer, a normalization operation on the plurality of combined embeddings to obtain the plurality of contextualized embeddings, at step 314.

Upon generating the plurality of contextualized embeddings, the process 300 may include predicting, by a sequence classifier module (such as the sequence classifier module 208), a named entity tag from a set of named entity tags for each of the plurality of contextualized embeddings using a fine-tuned second ANN layer, at step 316. The step 316 may include steps 318, 320, and 322. To predict the named entity tag for each of the plurality of contextualized embeddings, the process 300 may include performing, by the sequence classifier module, through the fine-tuned second ANN layer, a thresholding operation on the plurality of contextualized embeddings, at step 318.

Further, for each of the plurality of contextualized embeddings, the process 300 may include calculating, by the sequence classifier module, through the fine-tuned second ANN layer, a probability vector corresponding to the set of named entity tags using a linear layer and a sigmoid activation function, at step 320. It should be noted that the probability vector may include a probability score of a contextualized embedding corresponding to each of the set of named entity tags. Further, upon calculating the probability vector, for each of the plurality of contextualized embeddings, the process 300 may include determining, by the sequence classifier module, through the fine-tuned second ANN layer, the named entity tag based on the calculated probability vector, at step 322.

Further, upon predicting the named entity tag for each of the plurality of contextualized embeddings, the process 300 may include extracting, by the sequence classifier module, one or more skills from the electronic document based on the named entity tag corresponding to each of the plurality of contextualized embeddings, at step 324. Each of the one or more skills is a span of one or more contextualized embeddings corresponding to one or more words. Further, upon extracting the one or more skills, the process 300 may include rendering, by the sequence classifier module via the user interface, the one or more skills extracted from the electronic document on the user device, at step 326.

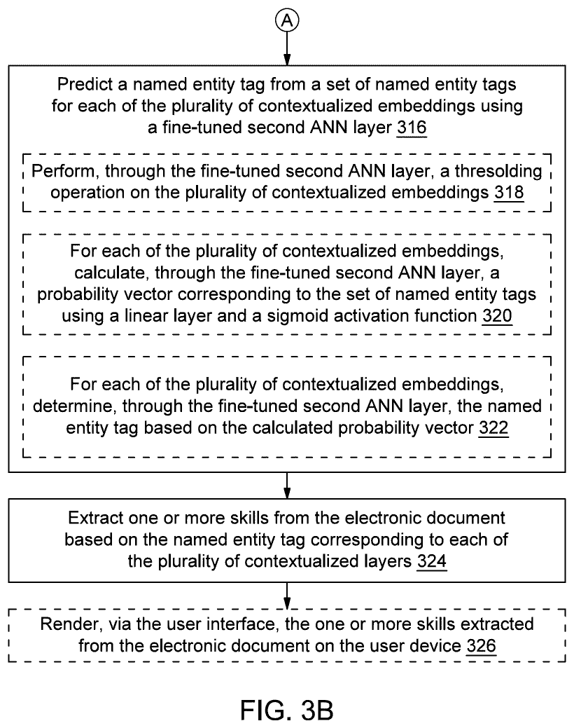

Referring now to FIG. 4, a detailed exemplary process 400 for contextualized skill extraction from electronic documents is illustrated via a flow chart, in accordance with some embodiments of the present disclosure. The process 400 may be implemented by the computing device 102 of the system 100. FIG. 4 is explained in conjunction with FIGS. 2 and 3. In an embodiment, the process 400 may include generating, by the token representation module 204, a plurality of token embeddings (analogous to the plurality of first embeddings) corresponding to a set of words of an electronic document using a fine-tuned pre-trained textual encoder, at step 402.

Initially, the token representation module 204 may provide the electronic document (e.g., a resume or a job description) to a fine-tuned pre trained textual encoder (i.e., the pre-trained embedding model) via the user interface 202 from which one or more skills needs to be extracted. By way of an example, the fine-tuned pre-trained textual encoder may be a JOBBERT. The electronic document may be provided in a PDF format to the fine-tuned pre-trained textual encoder. The electronic document may include a set of sentences (or sequences). The electronic document may be represented as where ‘d∈D’. Each set of sentences within each ‘D’ may include a set of words (or tokens).

By way of an example, the i^{th} set of sentences for each ‘D’ may be represented as

$$‘ {X}_{d}^{i} = \{ {x}_{1} , {x}_{2} , … {x}_{n} \} ’ ,$$

where ‘{x₁, x₂, . . . xₙ}’ corresponds to the tokens of the ‘i^{th}’ set of sequences, and ‘n’ corresponds to a sentence (or sequence) length.

Further, each of the set of sentences may be provided to the fine-tuned pre-trained textual encoder in a unified manner for further processing. Further, upon receiving the unified set of sentences, the fine-tuned pre-trained textual encoder may process the unified set of sentences to compute interaction between all tokens (i.e., X_{d}ⁱ={x₁, x₂, . . . xₙ}) to generate the plurality of token embeddings. Each of the set of words may be first tokenized into a plurality of sub-words to handle vocabulary in large pre-trained textual encoder (e.g., BERT). For each word in the electronic document ‘D’, the plurality of token embeddings of the first sub-words may be used to ensure consistency while capturing key terms (i.e., specific skills, or qualifications).

By way of an example, if a sentence may be ‘Computer Science Engineering’, then the fine-tuned pre-trained textual encoder may divide ‘Computer’ into two sub-words such as ‘Comput’ and ‘er’, and only the embedding of ‘Comput’ may be used for further processing. This may help to maintain consistency while capturing other related terms like ‘Compute’, ‘Computation’, or the like.

In continuation with the above example,

$${h}_{d} = {\{ {h}_{i} \}}_{0}^{N} ∈ {R}^{N \times {dim}^{′}}$$

may represent a textual encoder output for each token corresponding to the plurality of token embeddings, where ‘N≈n’ corresponds to the sentence length and ‘dim’ corresponds to the embedding dimension. In an embodiment, only the last layer of the JOBBERT may be used for the plurality of token embeddings. Further, the token representation module 204 may send the plurality of token embeddings to the skill representation learning module 206.

Upon receiving the plurality of token embeddings, the process 400 may include generating, by the skill representation learning module 206, a plurality of contextualized embeddings from the plurality of token embeddings using a first MLP layer (analogous to the first ANN layer) and an addition and normalization layer, at step 404. To generate the plurality of contextualized embeddings, initially, the fine-tuned first MLP layer may receive the plurality of token embeddings from the token representation module 204. Further, upon receiving the plurality of token embeddings, the fine-tuned first MLP layer may generate a plurality of enhanced embeddings (analogous to the plurality of second embeddings) from the plurality of token embeddings based on a weighted averaging operation.

To generate the plurality of enhanced embeddings, the fine-tuned first MLP layer may perform the weighted average operation on each of the plurality of token embeddings using fully connected position wise feed-forward network. In the weighted average operation, the fine-tuned first MLP layer may compute a weighted average score corresponding to each of the plurality of token embeddings based on a learnable weight matrix to obtain the plurality of enhanced embeddings. Further, upon preforming the weighted average operation on the plurality of token embeddings, the important tokens may be emphasized as compared to less relevant tokens.

In continuation with the above example, the weights ‘σ(w·hᵢ)’ may adjust the influence of each token of the plurality of token embeddings based on its importance, where ‘w’ corresponds to the learnable weight matrix, and ‘hᵢ’ corresponds to the plurality of token embeddings. The learnable weight matrix may allow the fine-tuned first MLP layer to dynamically prioritize key terms in the electronic document.

Further, upon generating the plurality of enhanced embeddings, the fine-tuned MLP layer may send the plurality of enhanced embeddings to the fine-tuned addition and normalization layer. Further, the addition and normalization layer may perform an addition operation on the plurality of enhanced embeddings with the plurality of token embeddings to obtain a plurality of combined embeddings. Upon obtaining the plurality of combined embeddings, the addition and normalization layer may perform a normalization operation on the plurality of combined embeddings to obtain the plurality of contextualized embeddings. The addition and normalization layer may stabilize the learning process by ensuring that the plurality of contextualized embeddings remain within a manageable range.

In continuation with the above example, the final normalized embeddings output

$$‘ {h}_{d}^{f} ’$$

may provide a refined and stable plurality of feature embeddings for the electronic document. This may enable the model (i.e., the second MLP layer) to better understand nuanced phrases or multi-word spans.

Further, the final distributed embeddings

$$‘ {h}_{d}^{f} ∈ {R}^{N \times dim} ’$$

corresponding to the electronic document may be calculated as shown in equation 1, where ‘σ’ corresponds to a sigmoid(·), and w∈R^{N×dim} corresponds to the learnable weight matrix.

$${h}_{d}^{f} = norm ( {h}_{i} + MLP ( \frac{σ ( w \cdot {h}_{i} )}{{\sum }_{i = 1}^{n} σ ( w \cdot {h}_{i} )} {h}_{i} ) ) \qquad Eq . 1$$

The equation ‘1’, may provide a combination of weighted averaging, the fine-tuned MLP transformation, and the normalization, which may create a robust, context-aware plurality of contextualized embeddings of the electronic document.

Further, upon generating the plurality of contextualized embeddings, the process 400 may include predicting, by the sequence classifier module 208, a probability score for a set of named entity tags corresponding to the plurality of contextualized embeddings using a fine-tuned second MLP layer (analogous to the second ANN layer), at step 406. The fine-tuned second MLP layer may pass the plurality of contextualized embeddings through a series of layers that may transform the plurality of contextualized embeddings into the desired format for downstream tasks. In particular, the fine-tuned second MLP layer may include two linear layers. In between two layers the fine-tuned second MLP layer may include a ReLU activation function.

The fine-tuned second MLP layer may transform the plurality of contextualized embeddings (i.e., aggregated dim-dimensional embedding) into a plurality of output embeddings

$$( e . g . , {ϕ}_{d}^{i} ( {X}_{d}^{i} ) \approx {\hat{Y}}_{d}^{i} \approx {Y}_{d}^{i} of input {X}_{d}^{i} ) .$$

The fine-tuned second MLP layer may convert very low (or negative) valued weighted average score into zero corresponding to each plurality of contextualized embeddings. Further, once the plurality of output embeddings is generated, then, the plurality of output embeddings may be passed through a linear layer of a projection layer. Further, the plurality of output embeddings may be passed through a sigmoid activation function to generate the probability score corresponding to each token being a part of a skill span (i.e., ‘B’, ‘l’, and ‘O’ tags).

In continuation with the above example, for each token ‘xⱼ’ in the set of sentences

$$‘ {X}_{d}^{i} ’ ,$$

the JOBBERT may produce a probability score ‘φ(xⱼ)’. The probability score may represent the likelihood of the token belonging to a particular class (B, I, or O).

Further, upon predicting the probability score corresponding to the plurality of contextualized embeddings, the process 400 may include extracting, by the sequence classifier module 208, one or more skills of the electronic document using the generated probability scores for the B-I-O tags, at step 408. The fine-tuned second MLP layer may employ a greedy based decoding method on the probability score corresponding to the B-I-O tags to select a topmost probable class from B-I-O class (i.e., a set of named entity tags) for a sequence labelling task. The highest probability score out of the ‘B’ tag, the ‘I’ tag, and the ‘O’ tag may be taken as an actual output tag. The predicted B-I-O tags for each token corresponding to plurality of contextualized embeddings may be used to identify and extract the one or more skill and their spans from the electronic document.

Further, the fine-tuned second MLP layer may generate a set of predicted layers corresponding to each token of the plurality of contextualized embeddings using a sequence labeling technique. The sequence labeling technique may be used to identify which tokens correspond to skills and which tokens may not.

It should be noted that ‘B’ labels followed by ‘I’ labels may be extracted for multiword-based skills (e.g., ‘B-I-I’ for a three-word skill) and only ‘B’ labels may be extracted for single-word-based skills. All the tokens that are labeled as ‘O’ in the sequence may be discarded.

Thus, this process ensures accurate identification and extraction of both multiword and single-word skills from electronic documents. For an example, if the resume mentions that “the candidate is proficient in Machine Learning Algorithms.” The following tagging is performed: Machine: B (Beginner); Learning: I (Intermediate); Algorithms: I (Intermediate), and finally the extracted skill span: “Machine Learning Algorithms” with tags ‘B-I-I’. For single-word skills, only the ‘B’ tag is used. As a specific example, if “the candidate is skilled in Python.” The following tagging is performed: Python: B (Beginner), and the extracted skill span: “Python” with the tag ‘B’. By way of another example, a candidate should have experience in Amazon Web Services, Java, and Python. In such cases, the fine-tuned second MLP layer may predict probability vector (i.e., for each B-I-O tags) for each word in the sentence. For example, a probability vector for the word ‘Amazon’ ‘Web’, and ‘Services’ may be [0.7, 0.4, 0.2], [0.3, 0.5, 0.1], and [0.2, 0.4, 0.1] respectively.

For the word ‘Amazon’, the probability vector may include a probability of 0.7 corresponding to the ‘B’ tag, a probability of 0.4 corresponding to the ‘I’ tag, and a probability of 0.2 corresponding to the ‘O’ tag. Then, the named entity tag corresponding to the word (i.e., Amazon) may be determined as the ‘B’ tag.

Similarly, for the word ‘Web’, the probability vector may include a probability of 0.3 corresponding to the ‘B’ tag, a probability of 0.5 corresponding to the ‘I’ tag, and a probability of 0.1 corresponding to the ‘O’ tag. Then, the named entity tag corresponding to the word (i.e., Web) may be determined as the ‘I’ tag.

For the word ‘Services’, the probability vector may include a probability of 0.2 corresponding to the ‘B’ tag, a probability of 0.4 corresponding to the ‘I’ tag, and a probability of 0.1 corresponding to the ‘O’ tag. Then, the named entity tag corresponding to the word (i.e., Services) may be determined as the ‘I’ tag.

Once the one or more skills are extracted, the sequence classifier module 208 may render, via the user interface 202, the one or more skills from the electronic document on a user device (e.g., a laptop). In continuation with the above example, the fine-tuned second MLP layer may render the one or more skills along with the corresponding tags (e.g., Amazon-‘B’ tag, Web-‘I’ tag, and Services-‘I’ tag) on the user device. Thus, the skill (i.e., Amazon Web Services with B-I-I) may be considered as a skill span.

Referring now to FIG. 5, a functional block diagram of a system 500 for fine-tuning an ANN model using a fine-tuning dataset is illustrated, in accordance with some embodiments of the present disclosure. FIG. 5 is explained in conjunction with FIGS. 2-4. The system 500 may be analogous to the system 100. The system 500 may include the user interface 202. The memory 106 of the computing device 102 may include the token representation module 204, the skill representation learning module 206, the sequence classifier module 208, and an evaluation optimization module 214. The skill representation learning module 206 may further include the MLP module 210, and the normalization module 212.

Initially, for a training phase, the token representation module 204 may receive, via the user interface 202, a training dataset (or a fine-tuning dataset). The training dataset may include a plurality of electronic documents. Each of the plurality of electronic documents may include a set of pre-labelled textual data. In particular, each of the plurality of electronic documents may include a set of sentences (sequences). Each of the set of sentences may include a set of words. Upon receiving the plurality of electronic documents, the token representation module 204 may compute a plurality of first embeddings corresponding to each of the set of words in each of the plurality of electronic documents using a pre-trained textual encoder (analogous to the embedding model). Further, the token representation module 204 may provide the plurality of token embeddings to the MLP module 210 and the normalization module 212 within the skill representation learning module 206.

The MLP module 210 may generate a plurality of enhanced embeddings (analogous to the plurality of second embeddings) from the plurality of token embeddings based on a weighted average operation using a first ANN layer. The MLP module 210 may perform the weighted average operation on the plurality of token embedding using the first ANN layer. The first ANN layer may use a fully connected position wise feed-forward network for the weighted average operation. For the weighted average operation, the MLP module 210 may compute a weighted average score corresponding to each of the plurality of token embeddings based on a learnable weight matrix using the first ANN layer to obtain the plurality of enhanced embeddings.

Upon implementing the weighted average operation on each of the plurality of token embeddings, the important tokens may be emphasized as compared to less relevant tokens. Further, the MLP module 210 may provide the plurality of enhanced embeddings to the normalization module 212. Further, the normalization module 212 may generate a plurality of contextualized embeddings from the plurality of enhanced embeddings and the plurality of token embeddings using an addition and normalization layer. The plurality of token embeddings may be received priorly from the token representation module 204.

To generate the plurality of contextualized embeddings, the normalization module 212 may perform, through the addition and normalization layer, an addition operation on the plurality of enhanced embeddings with the plurality of token embeddings to obtain a plurality of combined embeddings. Further, the normalization module 212 may perform, through the addition and normalization layer, a normalization operation on the plurality of combined embeddings to obtain the plurality of contextualized embeddings. Further, the normalization module 212 may provide the plurality of contextualized embeddings to the sequence classifier module 208.

Further, the sequence classifier module 208 may predict a named entity tags from a set of named entity tags for each of the plurality of contextualized embeddings using a second ANN layer. The named identity tags, for example, may be, but may not be limited to, a ‘B’ tag, an ‘I’ tag, and an ‘O’ tag. Further, the sequence classifier module 208 may provide the predicted probability scores to the evaluation and optimization module 214.

Further, upon receiving the predicted probability scores, the evaluation and optimization module 214 may calculate a loss function based on a comparison of the calculated probability vector with a ground truth probability vector (or actual probability vector) for each of the plurality of contextualized embeddings. The evaluation and optimization module 214 may receive, via the user interface, the ground truth probability vector from the user device.

Further, the evaluation and optimization module 214 may calculate the function loss corresponding to the plurality of contextualized embeddings using the predicted three-element probability vector having predicted probability scores for the B-I-O tags and the three-element probability vector corresponding to the actual tags.

Further, the evaluation and optimization module 214 may modify a plurality of hyperparameters of each of the first ANN layer, the addition and normalization layer, and the second ANN layer based on the loss function. In other words, the evaluation and optimization module 214 may provide feedback to the token representation module 204 based on the loss function corresponding to the predicted and actual named entity tags for fine-tuning hyperparameters of the pre-trained textual encoder.

Similarly, the evaluation and optimization module 214 may provide feedback to the MLP module 210 based on the loss function of the predicted and actual named entity tags corresponding to each of the set of words in each of the plurality of electronic documents for fine-tuning hyperparameters of the first ANN layer.

The evaluation and optimization module 214 may provide feedback to the sequence classifier module 208 based on the loss function of the predicted and actual named entity tags corresponding to each of the set of words in each of the plurality of electronic documents for fine-tuning hyperparameters of the second ANN layer.

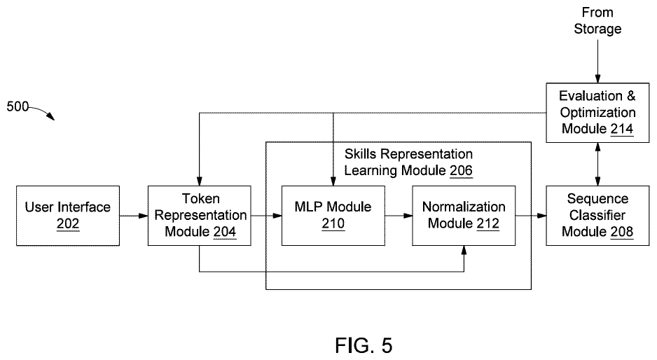

Referring now to FIG. 6, an exemplary process 600 for fine-tuning an ANN model using a fine-tuning dataset is illustrated via a flow chart, in accordance with some embodiments of the present disclosure. FIG. 6 is explained in conjunction with FIGS. 2-5. The process 600 may be implemented by the computing device 102 of the system 100. In some embodiments, the process 600 may include fine-tuning, by an evaluation and optimization module (such as the evaluation and optimization module 214) the first layer, the addition and normalization layer, and the second MLP layer using the fine-tuning dataset, at step 602. To fine-tune each layer, the process 600 may include determining, by the evaluation and optimization module, a loss function based on a comparison of the calculated probability vector with a ground truth probability vector for each of the plurality of contextualized embeddings, at step 604. Further, once the loss function is determined, the process 600 may include modifying, by the evaluation and optimization module, a plurality of hyperparameters of each of the first MLP layer, the addition and normalization layer, and the second MLP layer based on the loss function, at step 606.

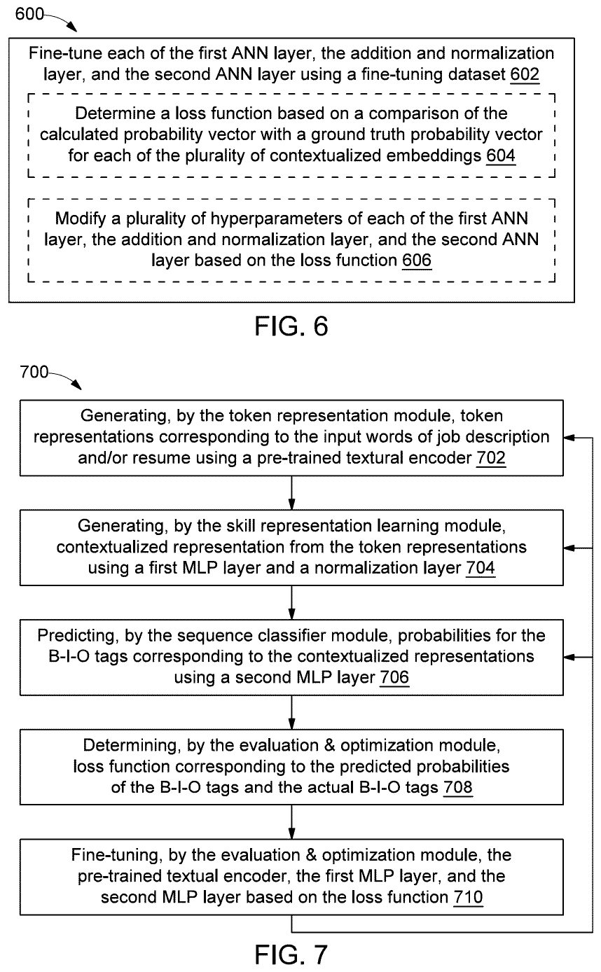

Referring now to FIG. 7, a detailed exemplary process 700 for fine-tuning an ANN model using a fine-tuning dataset is illustrated via a flow chart, in accordance with some embodiments of the present disclosure. The process 700 may be implemented by the computing device 102 of the system 100. FIG. 7 is explained in conjunction with FIGS. 2-6. In an embodiment, the process 700 may include generating, by the token representation module 204, a plurality of token embeddings (analogous to the plurality of first embeddings) corresponding to each of a set of words in a plurality of electronic documents using a textual encoder, at step 702.

Initially, the token representation module 204 may provide a plurality of electronic documents to the pre-trained textual encoder (e.g., a JOBBERT). The pre-trained textual encoder may be a domain-specific pre-trained model that may be fine-tuned for job descriptions (or resumes). The pre-trained textual encoder allows to generate the plurality of token embeddings corresponding to each of the set of words in the plurality of electronic documents. The tokenized embeddings may better capture the semantics of the technical and the domain-specific language used in the job descriptions (or resumes). The plurality of electronic documents may be received from the user device as an input, via the user interface 202. Each of the plurality of electronic documents may be provided one-by-one to the pre-trained textual encoder. In some embodiments, the plurality of electronic documents may be provided simultaneously to the pre-trained textual encoder.

Each of the plurality of electronic documents may include a set of textual data. Each electronic document may be represented as ‘D’, where ‘d e D’. Each ‘D’ may include a set of sentences. The set of sentences may be configured to form entire electronic document. Each of the set of sentences within the ‘D’ may include a set of words.

By way of an example, consider i^{th} set of sentences for each ‘D’ that may be represented as

$$‘ {X}_{d}^{i} = \{ {x}_{1} , {x}_{2} , … {x}_{n} \} ’ ,$$

where ‘x₁, x₂, . . . xₙ’ corresponds to the set of words of the i^{th} set of sentences, and ‘n’ corresponds to the sentence length (or sequence length).

Further, the pre-trained textual encoder may receive the set of sentences in a unified manner from the token representation module 204. Further, the pre-trained textual encoder may process the unified set of sentences to compute interaction between each of the set of words

$$( i . e . , {X}_{d}^{i} = \{ {x}_{1} , {x}_{2} , … {x}_{n} \} )$$

to produce the plurality of token embeddings. Each word of the set of words may be first tokenized into a plurality of sub-words to handle vocabulary in the large pre-trained textual encoder (e.g., BERT). For each word in the electronic documents, the token embeddings of the first sub-word may be used to ensure consistency in capturing key terms (such as skills or qualifications).

In continuation with the above example,

$$‘ {h}_{d} = {\{ {h}_{i} \}}_{0}^{N} ∈ {R}^{N \times dim} ’$$

may represent an output for each word corresponding to the plurality of token embeddings from the textual encoder, where ‘N≈n’ corresponds to the sequence length and ‘dim’ corresponds to an embedding dimension. It should be noted that only the last layer of the pre-trained textual encoder may be taken for token embeddings.

Further, upon generating the plurality of token embeddings, the process 700 may include generating, by the skill representation learning module 206, a plurality of contextualized embeddings using a first MLP layer and an addition and normalization layer, at step 704. In some embodiments, the skill representation learning module 206 may generate directly the plurality of contextualized embeddings using a classifier layer alone. However, in such cases, output may be in overfitting of embeddings results and divergence of training after a few iterations.

In an embodiment, the MLP module 210 may include the first MLP layer. The MLP layer may enhance the token interaction, as empirically demonstrated by a smoother training-validation loss curve. By adding the first MLP layer on top of the pre-trained textual encoder model that offer several advantages such as enhanced transfer learning capabilities by leveraging differently learned features for related tasks, improves generalization, thereby enhancing feature learning capabilities. Additionally, the normalization module 212 may include the addition and normalization layer which may be added after the first MLP layer to further improve the overall model stability and convergence during training.

To generate the plurality of contextualized embeddings, the token representation module 204 may provide the plurality of token embeddings to the first MLP layer. Further, upon receiving the plurality of token embeddings, the first MLP layer may perform a weighted averaging operation using a fully connected position wise feed-forward network to obtain a plurality of enhanced embeddings (analogous to the plurality of second embeddings). For the weighted averaging operation, the first MLP layer may compute a weighted average score corresponding to each of the plurality of token embeddings based on a learnable weight matrix. By applying a weighted averaging operation to the plurality of token embeddings, important tokens may be emphasized compared to less relevant tokens based on the weighted average score.

In continuation with the above example, the weights ‘σ(w·hᵢ)’ may adjust the influence of each token based on its importance, where ‘w’ corresponds to the learnable weight matrix. The learnable weight matrix may allow the first MLP layer to dynamically prioritize key terms (such as specific skills or qualifications) in each of the plurality of electronic documents. Further, the first MLP layer may provide the plurality of enhanced embeddings to the addition and normalization layer.

Further, the addition and normalization layer may perform an addition operation on the plurality of enhanced embeddings with the plurality of token embeddings to obtain a plurality of combined embeddings. Further, the addition and normalization layer may perform a normalization operation on the plurality of combined embeddings to obtain the plurality of contextualized embeddings. The addition and normalization layer may stabilize the learning process by ensuring that the embedding remains within a manageable range.

In continuation with the above example, the final normalized embeddings output

$$‘ {h}_{d}^{f} ’$$

gives a refined and stable feature embedding for the job description (or resume) that may enable the model to better understand nuanced phrases or multi-word spans. Further, the final distributed embedding

$$‘ {h}_{d}^{f} ∈ {R}^{N \times dim} ’$$

for the job description (or resume) may be calculated as shown in below equation 1, where ‘σ’ corresponds to a sigmoid(·), and ‘w∈R^{N×dim}’ corresponds to a learnable weight matrix.

$${h}_{d}^{f} = norm ( {h}_{i} + MLP ( \frac{σ ( w \cdot {h}_{i} )}{{\sum }_{i = 1}^{n} σ ( w \cdot {h}_{i} )} {h}_{i} ) ) \qquad Eq . 1$$

The equation ‘1’ may provide a combination of weighted averaging operation, the MLP transformation, and the normalization which may create a robust, context-aware embeddings of the job description (or resume).

Further, upon receiving the plurality of contextualized embeddings, the process 700 may include predicting, by the sequence classifier module 208, probability score for the B-I-O tags (i.e., the named entity tags) corresponding to each of the plurality of contextualized embeddings using a second MLP layer, at step 706. The second MLP layer may pass the plurality of contextualized embeddings through a series of layers that may transform the plurality of contextualized embeddings into the desired format for downstream tasks. The second MLP layer may include two linear layers with a ReLU activation function may be included in between.

The second MLP layer may transform the plurality of contextualized embeddings (i.e., aggregated dim-dimensional embedding) into a plurality of output representation

$$( e . g . , {ϕ}_{d}^{i} ( {X}_{d}^{i} ) \approx {\hat{Y}}_{d}^{i} \approx {Y}_{d}^{i} )$$

of set of sentences

$$‘ {X}_{d}^{i} ’ .$$

The second MLP layer may convert all very low values (or negative values) weighted average scores corresponding to the plurality of contextualized embedding into zero value. Upon conversion, the second MLP layer may pass the plurality of output embeddings through a linear layer. Then, the second MLP layer may pass the plurality of output embeddings through a sigmoid activation function to generate the probability scores for each token being a part of a skill span (B, I, O tags).

In continuation with the above example, for each token (i.e., ‘xⱼ’) in the set of sentences

$$( i . e . , ‘ {X}_{d}^{i} ’ ) ,$$

the second MLP layer may produce a probability score. The probability score may be represented as ‘φ(xⱼ)’. The probability score may represent the likelihood of the token belonging to a particular class (e.g., ‘B’, ‘I’, or ‘O’). Once the probability scores are predicted, further, the second MLP layer may convert the probability scores corresponding to the B-I-O tags into a three-element probability vector having ‘B’, ‘I’, and ‘O’ tags and the corresponding probability scores.

Further, the process 700 may include determining, by the evaluation and optimization module 214, a loss function corresponding to the predicted probability scores of the B-I-O tags and an actual B-I-O tags, at step 708. In continuation with the above example, each word of the set of sentences may be pre-labelled as ‘B’, ‘I’, and ‘O’ tags. For example, a single word skill token may be labelled as ‘B’. In a multi-word skill, the first token may be labelled as ‘B’ and the next tokens in the multi-word skills may be labelled as ‘I’, and all other tokens may be labelled as ‘O’.

In continuation with the above example, the target sequence of B-I-O labels for the i^{th} set of sentence of ‘D’ i.e.

$${X}_{d}^{i} = \{ {x}_{1} , {x}_{2} , … {x}_{n} \}$$

may be represented as

$$‘ {Y}_{d}^{i} = \{ {y}_{1} , {y}_{2} , … {y}_{n} \} ’$$

where ‘y₁, y₂, . . . yₙ’ are labels (B, I, or O) corresponding to ‘x₁, x₂, . . . xₙ’ tokens of the i^{th} set of sentence respectively where ‘n’ correspond to a sentence length.

Further, the second MLP layer may convert actual B-I-O tags for each word into a three-element probability vector with score of ‘1’ for the actual tag and score of ‘0’ for the remaining two tags. Further, the second MLP layer may calculate the loss function based on a comparison between the predicted probability score for the B-I-O tags and the actual probability score of the B-I-O tags to optimize the hyperparameters of the models (i.e., the first MLP layer, the addition and normalization layer, and the second MLP layer).

In continuation with the above example, the training loss (e.g., Binary Cross Entropy (BCE) loss, [symbol] ) of the complete model (φ(·)) for an individual example, may include skills and spans and other tokens, as described below.

$${ℒ}_{B C E} ( {\hat{Y}}_{d}^{i} , {Y}_{d}^{i} ) = - {\sum }_{j} [ {Y}_{d}^{i} log ( {\hat{Y}}_{d}^{i} ) + ( 1 - {Y}_{d}^{i} ) log ( 1 - {\hat{Y}}_{d}^{i} ) ]$$

In the above equation,

$$‘ {Y}_{d}^{i} ’$$

corresponds to the corresponding labels, and

$$‘ {\hat{Y}}_{d}^{i} ’$$

corresponds to the predicted probability from the model.

Further, upon determining the loss function, the process 700 may include fine-tuning, by the evaluation and optimization module 214, the first MLP layer, the addition and normalization layer, and the second MLP layer based on the loss function, at step 710. The output of the loss function may be used to fine-tune the weights of the pre-trained JobBERT layer, the first MLP layer, and the second MLP layer. It should be noted that hyperparameters of each layer may be updated during the training phrase. By way of an example, an optimizer (e.g., AdamW optimizer) may be used for fine-tuning.

For the training phase, a first base learning rate may be used for the pre-trained textual encoder. A second base learning rate may be used for the first MLP layer and the second MLP layer (i.e., non-pretrained layers). The first MLP layer and the second MLP layer may have a width (e.g., 768) and a dropout rate (e.g., 0.4). Each layer may be trained for up to a specific number of steps (such as 32,000 steps, or the like) beginning with a 10% warmup phase, followed by a decay phase using a cosine scheduler.

The training phase may be an iterative process, in which the hyperparameters of the pre-trained textual encoder, the first MLP layer, and the second MLP layer may be fine-tuned to achieve a trained model that is used for the inference phase. This is already explained in greater detail in conjunction with FIGS. 2-4.

The model implemented via the system 100 (referred herein as ‘current model’) may be a lightweight model, dealing with less memory storage and computation resources. Where conventional models are generally deployed via cloud servers, the current model can be deployed as an adoptable, customizable, and reusable in-house model. By way of an example, Table 1 represents such a comparison between the current model and state of the art LLMs.

TABLE 1
Memory storage and computation resource consumption comparison
between the current model and state of the art LLMs

| | Current Model | GPT3.5 | GPT4 | LLAMA2 |
|---|---|---|---|---|
| Parameters | 0.11B | 200B | 1.7T | 13B-70B |
| Memory | 0.5-2 GB | 50+ GB | 600+ GB | 15+ GB |
| GPU/CPU | CPU/GPU(1) | GPU(n) | GPU(n) | GPU(n) |

By way of an example, Table 2 represents details of a dataset with annotated ground truth used to train and test the current model and the state of the art LLMs based on various accuracy parameters.

TABLE 2
Details of the dataset with annotated ground truth

| | | | | | No. of | No. of |
|---|---|---|---|---|---|---|
| | | No. of | No. of | No. of | Hard | Soft |
| | | Posts | Sentences | Tokens | Skills | Skills |
| Training | Technical | 80 | 3,156 | 56,549 | 2,188 | 1,237 |
| Data | Training | | | | | |
| | Generic | 60 | 1,674 | 36,995 | 781 | 984 |
| | Training | | | | | |
| | Total | 140 | 4,830 | 93,544 | 2,969 | 2,221 |
| Testing | Technical | 62 | 4,539 | 42,034 | 1,635 | 1,001 |
| Data | Testing | | | | | |

Table 3 shows the comparison between performance of the current model and the state of the art LLMs based on various accuracy parameters using the dataset described in Table 2.

TABLE 3
Performance of the current model and the state of the art LLMs

| Model | Precision | Recall | F1 |
|---|---|---|---|
| Current Model | 0.66 | 0.85 | 0.74 |
| LIGHTCAST | 0.24 | 0.48 | 0.32 |
| JOBBERT | 0.71 | 0.78 | 0.74 |
| SPANBERT | 0.71 | 0.76 | 0.73 |
| GPT3.5 | 0.72 | 0.64 | 0.68 |
| GPT4 | 0.74 | 0.73 | 0.73 |

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

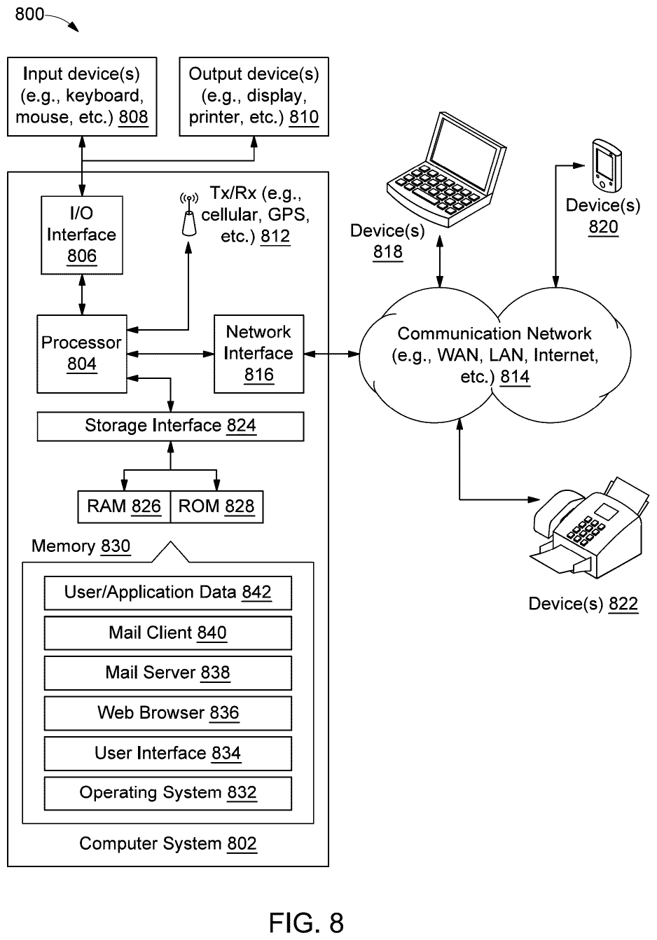

The disclosed methods and systems may be implemented on a conventional or a general-purpose computer system, such as a personal computer (PC) or server computer. Referring now to FIG. 8, a block diagram of an exemplary computer system 802 for implementing embodiments consistent with the present disclosure is illustrated. Variations of computer system 802 may be used for implementing system 800 for contextualized skill extraction from electronic documents. The computer system 802 may include a central processing unit (“CPU” or “processor”) 804. The processor 804 may include at least one data processor for executing program components for executing user-generated or system-generated requests. A user may include a person, a person using a device such as such as those included in this disclosure, or such a device itself. The processor 804 may include specialized processing units such as integrated system (bus) controllers, memory management control units, floating point units, graphics processing units, digital signal processing units, etc. The processor 804 may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 804 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The processor 804 may be disposed in communication with one or more input/output (I/O) devices via I/O interface 806. The I/O interface 806 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 806, the computer system 802 may communicate with one or more I/O devices. For example, the input device 808 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 810 may be a printer, fax machine, video display (e.g., cathode ray tube (CRT), liquid crystal display (LCD), light-emitting diode (LED), plasma, or the like), audio speaker, etc. In some embodiments, a transceiver 1612 may be disposed in connection with the processor 804. The transceiver may facilitate various types of wireless transmission or reception. For example, the transceiver may include an antenna operatively connected to a transceiver chip (e.g., TEXAS INSTRUMENTS® WILINK WL1286®, BROADCOM® BCM4550IUB8® INFINEON TECHNOLOGIES® X-GOLD 1436-PMB9800® transceiver, or the like), providing IEEE 802.11a/b/g/n, Bluetooth, FM, global positioning system (GPS), 2G/3G HSDPA/HSUPA communications, etc.

In some embodiments, the processor 804 may be disposed in communication with a communication network 816 via a network interface 814. The network interface 814 may communicate with the communication network 816. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 816 may include, without limitation, a direct interconnection, local area network (LAN), wide area network (WAN), wireless network (e.g., using Wireless Application Protocol), the Internet, etc. Using the network interface 814 and the communication network 816, the computer system 802 may communicate with devices 818, 820, and 822. These devices may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 802 may itself embody one or more of these devices.

In some embodiments, the processor 804 may be disposed in communication with one or more memory devices 830 (e.g., RAM 826, ROM 828, etc.) via a storage interface 824. The storage interface may connect to memory devices 830 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422, RS-485, 12C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices 830 may store a collection of program or database components, including, without limitation, an operating system 832, user interface application 834, web browser 836, mail server 838, mail client 840, user/application data 842 (e.g., any data variables or data records discussed in this disclosure), etc. The operating system 832 may facilitate resource management and operation of the computer system 802. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE ANDROID®, BLACKBERRY® OS, or the like. User interface 834 may facilitate display, execution, interaction, manipulation, or operation of program components through textual or graphical facilities. For example, user interfaces may provide computer interaction interface elements on a display system operatively connected to the computer system 802, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 802 may implement a web browser 836 stored program component. The web browser may be a hypertext viewing application, such as MICROSOFT® INTERNET EXPLORER®, GOOGLE® CHROME® MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 802 may implement a mail server 838 stored program component. The mail server may be an Internet mail server such as MICROSOFT® EXCHANGE®, or the like. The mail server may utilize facilities such as ASP, ActiveX, ANSI C++/C #, MICROSOFT.NET® CGI scripts, JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 802 may implement a mail client 840 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, computer system 802 may store user/application data 842, such as the data, variables, records, etc. (e.g., a plurality of electronic documents, a plurality of first embeddings, a plurality of contextualized embeddings, a plurality of second embeddings, and the like) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

Various embodiments provide method and system of contextualized skill extraction from electronic documents. The disclosed method and system may receive, via a user interface, an electronic document from a user device. The electronic document may include a plurality of words. Further, the disclosed method and system may generate a plurality of first embeddings corresponding to each of the plurality of words in the electronic document using a pre-trained embedding model. The plurality of first embeddings is based on a plurality of sub-words corresponding to the plurality of words. Further, the disclosed method and system may generate a plurality of second embeddings from the plurality of first embeddings based on a weighted averaging operation using a first ANN layer. Further, the disclosed method and system may generate a plurality of contextualized embeddings from the plurality of second embeddings and the plurality of first embeddings using an addition and normalization layer. Moreover, the disclosed method and system may predict a named entity tag from a set of named entity tags for each of the plurality of contextualized embeddings using a fine-tuned second ANN layer. Thereafter, the disclosed method and system may extract one or more skills from the electronic document based on the named entity tag corresponding to each of the plurality of contextualized layers. Each of the one or more skills is a span of one or more contextualized embeddings corresponding to one or more words.

Thus, the disclosed method and system try to overcome the technical problem of contextualized skill extraction from electronic documents. The disclosed method and system may extract skills more accurately from an electronic document. Additionally, the disclosed method and system may provide recruiters with a clear understanding of the required skills for each position. The disclosed method and system may provide more targeted candidate searches for job roles. The disclosed method and system may reduce time and resources spent on screening and evaluating applicants. The disclosed method and system may require small storage memory. The disclosed method and system may have better understanding over skill requirements of various roles within an organization. This may facilitate more strategic talent management, including identifying skill gaps, planning training programs, and optimizing workforce allocation to meet business objectives effectively. The disclosed method and system may provide better matching of candidates for job roles based on their skills and qualifications. This may enhance the likelihood of successful hiring and reduce turnover rates. By providing detailed insights into the skill composition of job descriptions, the disclosed method and system may support data-driven decision-making in HR processes. Organizations may analyze trends in skill demand, identify emerging skill requirements, and align workforce strategies accordingly to stay competitive in evolving markets.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of contextualized skill extraction from electronic documents, the method comprising:
receiving, by a computing device via a user interface, an electronic document from a user device, wherein the electronic document comprises a plurality of words;
generating, by the computing device, a plurality of first embeddings corresponding to each of the plurality of words in the electronic document using a pre-trained embedding model, wherein the plurality of first embeddings is based on a plurality of sub-words corresponding to the plurality of words;
generating, by the computing device, a plurality of second embeddings from the plurality of first embeddings based on a weighted averaging operation using a first Artificial Neural Network (ANN) layer;
generating, by the computing device, a plurality of contextualized embeddings from the plurality of second embeddings and the plurality of first embeddings using an addition and normalization layer;
predicting, by the computing device, a named entity tag from a set of named entity tags for each of the plurality of contextualized embeddings using a fine-tuned second ANN layer; and
extracting, by the computing device, one or more skills from the electronic document based on the named entity tag corresponding to each of the plurality of contextualized layers, wherein each of the one or more skills is a span of one or more contextualized embeddings corresponding to one or more words.

2. The method of claim 1, wherein the weighted averaging operation comprises computing a weighted average score corresponding to each of the plurality of first embeddings based on a learnable weight matrix using the first ANN layer, to obtain the plurality of second embeddings.

3. The method of claim 1, wherein generating the plurality of contextualized embeddings comprises:
performing, through the addition and normalization layer, an addition operation on the plurality of second embeddings with the plurality of first embeddings, to obtain a plurality of combined embeddings; and
performing, through the addition and normalization layer, a normalization operation on the plurality of combined embeddings to obtain the plurality of contextualized embeddings.

4. The method of claim 1, wherein predicting the named entity tag comprises:
performing, through the fine-tuned second ANN layer, a thresholding operation on the plurality of contextualized embeddings;
for each of the plurality of contextualized embeddings, calculating, through the fine-tuned second ANN layer, a probability vector corresponding to the set of named entity tags using a linear layer and a sigmoid activation function, wherein the probability vector comprises a probability score of a contextualized embedding corresponding to each of the set of named entity tags; and
for each of the plurality of contextualized embeddings, determining, through the fine-tuned second ANN layer, the named entity tag based on the calculated probability vector.

5. The method of claim 1, further comprising fine-tuning each of the first ANN layer, the addition and normalization layer, and the second ANN layer using a fine-tuning dataset to obtain the fine-tuned ANN, wherein the fine-tuning comprises:
determining a loss function based on a comparison of the calculated probability vector with a ground truth probability vector for each of the plurality of contextualized embeddings; and
modifying a plurality of hyperparameters of each of the first ANN layer, the addition and normalization layer, and the second ANN layer based on the loss function.

6. The method of claim 1, further comprising rendering, via the user interface, the one or more skills extracted from the electronic document on the user device.

7. A system for contextualized skill extraction from electronic documents, the system comprising:
a processor; and
a memory communicatively coupled to the processor, wherein the memory stores processor executable instructions, which, on execution, causes the processor to:
receive, via a user interface, an electronic document from a user device, wherein the electronic document comprises a plurality of words;
generate a plurality of first embeddings corresponding to each of the plurality of words in the electronic document using a pre-trained embedding model, wherein the plurality of first embeddings is based on a plurality of sub-words corresponding to the plurality of words;
generate a plurality of second embeddings from the plurality of first embeddings based on a weighted averaging operation using a first Artificial Neural Network (ANN) layer;
generate a plurality of contextualized embeddings from the plurality of second embeddings and the plurality of first embeddings using an addition and normalization layer;
predict a named entity tag from a set of named entity tags for each of the plurality of contextualized embeddings using a fine-tuned second ANN layer; and
extract one or more skills from the electronic document based on the named entity tag corresponding to each of the plurality of contextualized layers, wherein each of the one or more skills is a span of one or more contextualized embeddings corresponding to one or more words.

8. The system of claim 7, wherein the weighted averaging score, the processor executable instructions further cause the processor to compute a weighted average score corresponding to each of the plurality of first embeddings based on a learnable weight matrix using the first ANN layer, to obtain the plurality of second embeddings.

9. The system of claim 7, wherein generating the plurality of contextualized embeddings, the processor executable instructions further cause the processor to:
perform, through the addition and normalization layer, an addition operation on the plurality of second embeddings with the plurality of first embeddings, to obtain a plurality of combined embeddings; and
perform, through the addition and normalization layer, a normalization operation on the plurality of combined embeddings to obtain the plurality of contextualized embeddings.

10. The system of claim 7, wherein predicting the named entity tag, the processor executable instructions further cause the processor to:
perform, through the fine-tuned second ANN layer, a thresholding operation on the plurality of contextualized embeddings;
for each of the plurality of contextualized embeddings, calculate, through the fine-tuned second ANN layer, a probability vector corresponding to the set of named entity tags using a linear layer and a sigmoid activation function, wherein the probability vector comprises a probability score of a contextualized embedding corresponding to each of the set of named entity tags; and
for each of the plurality of contextualized embeddings, determine, through the fine-tuned second ANN layer, the named entity tag based on the calculated probability vector.

11. The system of claim 7, wherein the processor executable instructions further cause the processor to fine-tune each of the first ANN layer, the addition and normalization layer, and the second ANN layer using a fine-tuning dataset to obtain the fine-tuned ANN, wherein the fine-tuning comprises:
determine a loss function based on a comparison of the calculated probability vector with a ground truth probability vector for each of the plurality of contextualized embeddings; and
modify a plurality of hyperparameters of each of the first ANN layer, the addition and normalization layer, and the second ANN layer based on the loss function.

12. The system of claim 7, wherein the processor executable instructions further cause the processor to render, via the user interface, the one or more skills extracted from the electronic document on the user device.

13. A non-transitory computer-readable medium storing computer-executable instructions for contextualized skill extraction from electronic documents, the computer-executable instructions configured for:
receiving, via a user interface, an electronic document from a user device, wherein the electronic document comprises a plurality of words;
generating a plurality of first embeddings corresponding to each of the plurality of words in the electronic document using a pre-trained embedding model, wherein the plurality of first embeddings is based on a plurality of sub-words corresponding to the plurality of words;
generating a plurality of second embeddings from the plurality of first embeddings based on a weighted averaging operation using a first Artificial Neural Network (ANN) layer;
generating a plurality of contextualized embeddings from the plurality of second embeddings and the plurality of first embeddings using an addition and normalization layer;
predicting a named entity tag from a set of named entity tags for each of the plurality of contextualized embeddings using a fine-tuned second ANN layer; and
extracting one or more skills from the electronic document based on the named entity tag corresponding to each of the plurality of contextualized layers, wherein each of the one or more skills is a span of one or more contextualized embeddings corresponding to one or more words.

14. The non-transitory computer-readable medium of claim 13, wherein the weighted averaging operation, the computer-executable instructions are further configured for computing a weighted average score corresponding to each of the plurality of first embeddings based on a learnable weight matrix using the first ANN layer, to obtain the plurality of second embeddings.

15. The non-transitory computer-readable medium of claim 13, wherein generating the plurality of contextualized embeddings, the computer-executable instructions are further configured for:
performing, through the addition and normalization layer, an addition operation on the plurality of second embeddings with the plurality of first embeddings, to obtain a plurality of combined embeddings; and
performing, through the addition and normalization layer, a normalization operation on the plurality of combined embeddings to obtain the plurality of contextualized embeddings.

16. The non-transitory computer-readable medium of claim 13, wherein predicting the named entity tag, the computer-executable instructions are further configured for:
performing, through the fine-tuned second ANN layer, a thresholding operation on the plurality of contextualized embeddings;
for each of the plurality of contextualized embeddings, calculating, through the fine-tuned second ANN layer, a probability vector corresponding to the set of named entity tags using a linear layer and a sigmoid activation function, wherein the probability vector comprises a probability score of a contextualized embedding corresponding to each of the set of named entity tags; and
for each of the plurality of contextualized embeddings, determining, through the fine-tuned second ANN layer, the named entity tag based on the calculated probability vector.

17. The non-transitory computer-readable medium of claim 13, wherein the computer-executable instructions are further configured for fine-tuning each of the first ANN layer, the addition and normalization layer, and the second ANN layer using a fine-tuning dataset to obtain the fine-tuned ANN, wherein the fine-tuning comprises:
determining a loss function based on a comparison of the calculated probability vector with a ground truth probability vector for each of the plurality of contextualized embeddings; and
modifying a plurality of hyperparameters of each of the first ANN layer, the addition and normalization layer, and the second ANN layer based on the loss function.

18. The non-transitory computer-readable medium of claim 19, wherein the computer-executable instructions are further configured for rendering, via the user interface, the one or more skills extracted from the electronic document on the user device.
